(19) United States
(12) Patent Application Publication
(10) Pub. No.: US 2016/0364815 A1
(43) Pub. Date: Dec. 15, 2016

(54) Multi-Passenger Travel Booking Platform

(71) Applicant: Amgine Technologies (US), Inc., Austin, TX (US)

(72) Inventors: Harold Roy Miller, Toronto (CA); Jonathan David Miller, Toronto (CA); L. James Valverde, JR., Washington, DC (US)

(21) Appl. No.: 15/178,064

(22) Filed: Jun. 9, 2016

Related U.S. Application Data
(60) Provisional application No. 62/174,387, filed on Jun. 11, 2015.

(51) Int. Cl. G06Q 50/14; G06F 17/30; G06Q 10/02; G06F 17/27

(52) U.S. Cl. CPC G06Q 50/14; G06F 17/2705; G06F 17/30867; G06F 17/3053; G06Q 10/02; G06F 17/30554

(57) ABSTRACT

A method and system for facilitating multi-passenger travel reservations are described. The method may commence with receiving a travel-related query associated with a plurality of passengers. The method may continue with ascertaining, based on the travel-related query, a plurality of attribute sets for each of the plurality of passengers. The method may further include parsing the travel-related query to derive attribute values related to the plurality of attribute sets. Upon parsing, at least one attribute of the plurality of attribute sets may be instantiated with the derived attribute values. The method may include searching, for each of the plurality of passengers, for feasible travel itineraries based on the least one attribute and user preferences and presenting at least one multi-passenger travel itinerary for each of the plurality of passengers.

### CROSS-REFERENCE TO RELATED APPLICATION

The present utility patent application is related to and claims the priority benefit under 35 U.S.C. 119(e) of U.S. provisional application No. 62/174,387, filed on Jun. 11, 2015, and titled “Multi-Passenger Travel Booking Platform.” The disclosure of this related provisional application is incorporated herein by reference for all purposes to the extent that such subject matter is not inconsistent herewith or limiting hereof.

### TECHNICAL FIELD

The present disclosure relates to data processing and, more particularly, to facilitating travel reservations using a multi-passenger travel booking platform.

### BACKGROUND

Travel consumers enjoy the benefits of a plurality of various options. Numerous information sources provide travel-related information and advice on everything from destinations to hotels, as well as related points of interest. There is a reasonable degree of price transparency for a vast array of travel-related goods and services. While consumers derive much utility from this choice environment enabled by online travel agencies (OTAs) and travel websites, a choice task of the travel consumer is often encumbered by information abundance and by legacy technology platforms that almost invariably complicate the consumer choice problem. For the average consumer, these choice-related challenges take many forms, such as, for example, a plurality of travel-related goals and objectives pertaining to all of the relevant facets and phases of the travel planning process; the existence of a large number of viable itinerary options to sort through, evaluate, and ultimately choose from; the existence of disparate and non-homogenous information sources, all of which possess varying degrees of quality, usefulness, and reliability; the need to consider complex value trade-offs among key choice attributes and objectives (e.g., price vs. suitability of a selected flight for the consumer), together with the existence of often conflicting objectives (e.g., a desire for luxury, constrained by willingness-to-pay).

Moreover, results containing travel itineraries selected by OTAs and presented to the consumer may not demonstrate how satisfying a selected travel itinerary is for the consumer. More specifically, the consumer may need to know whether attributes having a prioritizing value for the consumer were taken into consideration by the OTAs during selection of the travel itineraries for the consumer.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a method for facilitating multi-passenger travel reservations is provided. The method may commence with receiving a travel-related query. The travel-related query may be associated with a plurality of passengers, such as with a group of users. The method may continue with ascertaining, based on the travel-related query, a plurality of attribute sets. Each of the plurality of attribute sets may be associated with one of the plurality of passengers. The method may further include parsing the travel-related query to derive attribute values related to the plurality of attribute sets. Upon parsing, at least one attribute of the plurality of attribute sets may be instantiated with the derived attribute values. The method may include searching, for each of the plurality of passengers, for feasible travel itineraries based on the least one attribute and user preferences. Based on the search, at least one multi-passenger travel itinerary for each of the plurality of passengers may be presented.

According to another example embodiment of the disclosure, a system for facilitating multi-passenger travel reservations is provided. The system may include a processor, a parser in communication with the processor, and a scheduler in communication with the processor. The processor may be operable to receive a travel-related query associated with a plurality of passengers. Based on the travel-related query, the processor may be operable to ascertain a plurality of attribute sets. Each of the plurality of attribute sets may be associated with one of the plurality of passengers. The scheduler may be operable to parse the travel-related query to derive attribute values related to the plurality of attribute sets. The processor may be operable to instantiate, for each of the plurality of passengers, at least one attribute of the plurality of attribute sets with the attribute values. The scheduler may be operable to search, for each of the plurality of passengers, for feasible travel itineraries based on the least one attribute and user preferences. The processor may be further operable to present, based on searching, at least one multi-passenger travel itinerary for each of the plurality of passengers.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for facilitating multi-passenger travel reservations can be implemented.

FIG. 2 is a block diagram showing various modules of a system for translating user requests into itinerary solutions.

FIG. 3 is a process flow diagram showing a method for facilitating multi-passenger travel reservations.

FIG. 4 illustrates a matrix for representation of multi-passenger travel itineraries.

FIGS. 5-15 show user interfaces associated with presenting multi-passenger travel itineraries in a system for facilitating multi-passenger travel reservations.

FIGS. 16-21 show user interfaces related to a user profile associated with a system for facilitating multi-passenger travel reservations.

FIG. 22 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The disclosure relates to a multi-passenger travel booking platform that enables itinerary options to be presented to a consumer for purchase consideration.

When a consumer needs to book a trip, e.g., a business trip, for a several passengers, the consumer may take a number of factors taken into consideration. In particular, even though a destination city of the trip may be the same, the origin cities of the passengers may differ. Additionally, each of the passengers may have his own preferences with respect to specific details of the trip, such as a hotel rating, minimal flight connecting time, a car model to be rented in the destination city, and so forth. To facilitate the making of travel reservations, a travel itinerary selected by the multi-passenger travel booking platform in response to a travel-related query of the consumer may be presented to the consumer so as to visualize multi-person (multi-passenger) itineraries, thereby efficiently and effectively conveying all relevant information pertaining to flights, hotels, and rental cars, together with any pertinent ancillary content.

More specifically, upon receipt of the travel-related query associated with several passengers, the multi-passenger travel booking platform may determine attribute sets for each of the passengers. The attribute sets may include, for example, an origin city, a destination city, and a hotel for a first passenger; an origin city, a destination city, a hotel, and a car reservation for a second passenger; and an origin city, a destination city, a flight date, a hotel, and a destination city for a return flight for a third passenger. The multi-passenger travel booking platform may parse the travel-related query to derive attribute values related to the attribute sets. For example, if the travel-related query is ‘Book tickets for a flight from New York to Chicago for tomorrow,’ the multi-passenger travel booking platform derives the attribute value “New York” for the attribute set “Origin City,” the attribute value “Chicago” for the attribute set “Destination City,” and the attribute value, based on a current date, for the attribute set “Date.”

Further, for each of the passengers, the multi-passenger travel booking platform may instantiate attributes of the attribute sets with the derived attribute values. Based on the attribute sets and the attribute values, the multi-passenger travel booking platform may search for feasible travel itineraries for each of the passengers. Upon the search, the multi-passenger travel booking platform may present a multi-passenger travel itinerary for each of the passengers. While depicting and visualizing multi-passenger itineraries for the consumer, the multi-passenger travel booking platform may utilize a graphical and visual language to convey defining elements of a multi-passenger itinerary. The defining elements may include, for example, flight-specific information, such as a time of a flight or number of connections, hotel-specific information, such as a hotel rating, or any other elements related to the travel. The defining elements of the multi-passenger itinerary may be presented to the consumer in the simplest and most efficient manner possible. The multi-passenger travel booking platform may use a column-centric architecture designed to provide an at-a-glance view of all information pertinent to a multi-passenger itinerary, including passenger-specific flight-, hotel-, and rental car-related information. More specifically, the multi-passenger travel itineraries may be presented as a table consisting of s columns, with each denoting names of the passenger parsed based on in the travel query, and r rows that may partition each column into regions that convey passenger-specific information, such as information pertaining to flights, hotels, car rental reservations, and so forth.

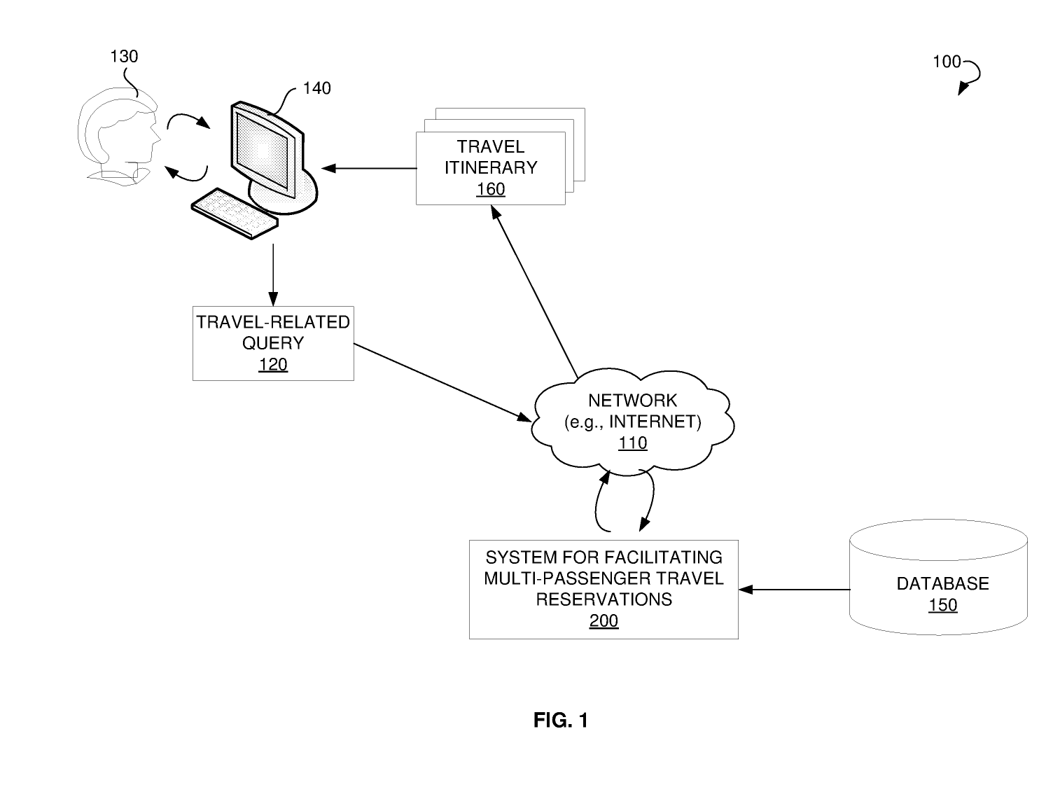

FIG. 1 illustrates an environment 100 within which the systems and methods for facilitating multi-passenger travel reservations can be implemented, in accordance with some embodiments. A travel-related query 120 associated with a plurality of users 130 may be received, for example, via a user interface displayed on a user device 140. The travel-related query 120 may include text data. The text data may be obtained as a natural language input by the users 130, by speech-to-text conversion of an oral exchange with the users 130, or otherwise.

The travel-related query 120 may be transmitted to a system 200 for facilitating multi-passenger travel reservations via a network 110. The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may be a network of data processing nodes that are interconnected for the purpose of data communication. The network 110 may include any suitable number and type of devices (e.g., routers and switches) for forwarding commands, content, and/or web object requests from each client to the online community application and responses back to the clients.

The user device 140, in some example embodiments, may include a Graphical User Interface (GUI) for displaying the user interface associated with the system 200. In a typical GUI, instead of offering only text menus or requiring typed commands, the system 200 may present graphical icons, visual indicators, or special graphical elements called widgets that may be utilized to allow the users to interact with the system. The user device 140 may be configured to utilize icons used in conjunction with text, labels, or text navigation to fully represent the information and actions available to the users.

The user device 140 may include a mobile telephone, a personal computer (PC), a laptop, a smart phone, a tablet PC, and so forth. In an example embodiment, the system 200 may be a server-based distributed application; thus, it may include a central component residing on a server and one or more client applications residing on one or more user devices and communicating with the central component via the network 110. The users 130 may communicate with the system 200 via a client application available through the user device 140.

Travel itineraries available from an optional database 150 may be analyzed with reference to user preferences. Travel itineraries 160 suiting the preferences of the user may be determined. Travel itineraries 160 may be presented to the users 130 by displaying travel itineraries 160 via the user interface on a screen of the user device 140.

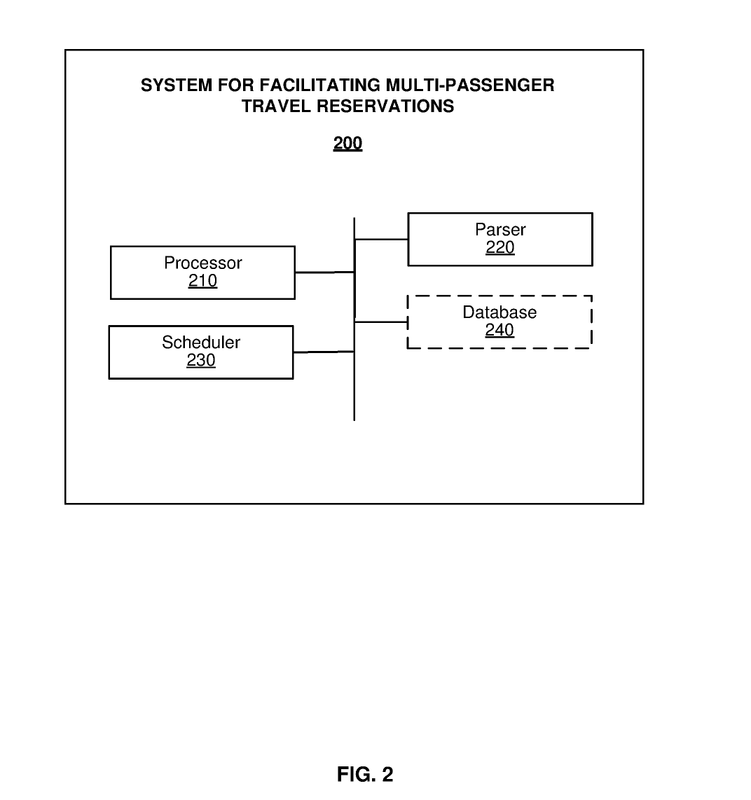

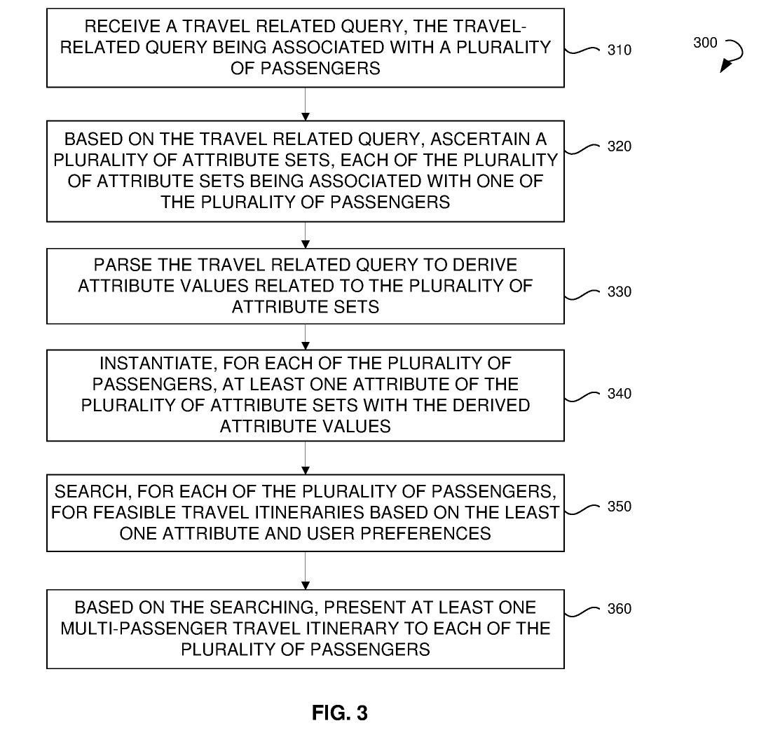

FIG. 2 shows a block diagram illustrating various modules of a system 200 for facilitating multi-passenger travel reservations, according to an example embodiment. Specifically, the system 200 may include a processor 210, a parser 220, a scheduler 230, and an optional database 240. The processor 210 may include a programmable processor, such as a microcontroller, central processing unit (CPU), and so forth. In other embodiments, the processor 210 may include an application-specific integrated circuit or programmable logic array, such as a field programmable gate array designed to implement the functions performed by the system 200. The processor 210, the parser 220, the scheduler 230, and the database 240 of the system 200 are described in detail with reference to FIG. 3.

FIG. 3 is a process flow diagram showing a method 300 for facilitating multi-passenger travel reservations within the environment described with reference to FIG. 1. The method 300 may commence with receiving, by the processor 210, a travel-related query at operation 310. In an example embodiment, the travel-related query may be provided via at least one of the following: a natural language, a typed text, a selection of preexisting options, and so forth. In a further example embodiment, the travel-related query may be associated with a plurality of passengers, such as with a group of users. The travel-related query may be provided by a user via a user device, such as via a text typed by the user using a GUI associated with the user device, or via a voice command of the user, which may be received by the user device, e.g., using a voice recognition unit of the user device. In some embodiments, to receive the travel-related query, the processor 210 may be operable to provide, in oral or written form, one or more motivating questions to the user.

The method 300 may continue with ascertaining, by the processor 210, based on the travel-related query, a plurality of attribute sets at operation 320. Each of the plurality of attribute sets may be associated with one of the plurality of passengers. For example, attributes of the attribute sets may include “Origin City,” “Destination City,” “Date,” and so forth.

At operation 330, the method 300 may include parsing, by the parser 220, the travel-related query to derive attribute values related to the plurality of attribute sets. For example, the attribute value “New York” may be derived for the attribute “Origin City,” the attribute value “Chicago” may be derived for the attribute “Destination City,” and so forth.

Upon the parsing, the processor 210 may instantiate at least one attribute of the plurality of attribute sets with the derived attribute values at operation 340.

At operation 350, the method 300 may include searching, by the scheduler 230, for each of the plurality of passengers, for feasible travel itineraries based on the least one attribute and user preferences. The scheduler 230 may search for feasible travel itineraries in the database 240.

Based on the search, the processor 210 may present at least one multi-passenger travel itinerary for each of the plurality of passengers at operation 360. In an example embodiment, the presenting of the one multi-passenger travel itinerary may include visualizing itinerary information associated with each of the plurality of passengers. The itinerary information may be associated with the at least one multi-passenger travel itinerary for each of the plurality of passengers. The itinerary information may include at least flight information and one or more of the following: hotel information, rental car information, and so forth.

The method 300 may further include receiving, by the processor 210, a revision request. The revision request may be associated with at least one of the plurality of passengers and may refer to an alteration of at least one of the attribute values or an addition of a further attribute value. Based on the revision request, the processor 210 may instantiate a further attribute with an altered derived attribute value or a further attribute value. Furthermore, based on the instantiation, the scheduler 220 may search for further feasible travel itineraries based on the further attribute.

The method 300 may further include ranking, by the processor 210, the at least one attribute based at least on user preferences. Upon the ranking, weights may be assigned to the at least one attribute by the processor 210 based on the ranking to create at least one weighted attribute.

In a further example embodiment, the presenting of the one multi-passenger travel itinerary may include identifying, by the processor 210, based on the assigned weights, one or more attributes having the highest weights. The one or more attributes having the highest weights may be visually marked out when being shown to the user.

In an example embodiment, the method 300 may further include selecting, by the processor, from the feasible travel itineraries, the at least one multi-passenger travel itinerary associated with the one or more attributes having the highest weights. Upon selecting, the selected at least one multi-passenger travel itinerary may be presented to the user as described above with respect to operation 360.

In some example embodiments, the presenting may further include providing visual cues associated with the one or more attributes that have the highest weights. Additionally, the presenting may include visualizing segments of the at least one multi-passenger travel itinerary. In a further example embodiment, the at least one multi-passenger travel itinerary for each of the plurality of passengers may be presented as a matrix (i.e., a table). The matrix may have a plurality of columns and a plurality of rows. Each of the columns may be associated with one of the plurality of passengers. Each of the rows may be associated with at least flight information. Each of the rows may be further associated with one or more of the following: hotel information, rental car information, return flight information, continuing flight information, and so forth.

The fulfillment of travel-related queries may require routing and scheduling capabilities (that can be provided by conventional OTAs) with identifying of feasible itinerary options for the user. In an example embodiment, a travel-related query, Q, may take the following form:

Q={qₛ,q_{d},qᵢ}, where
qₛ≡passenger starting point (airport, city, and the like);
q_{d}≡final destination;
qₜ≡duration of trip.
   Relative to the travel-related query, Q, the construction of feasible travel itineraries may involve routing and scheduling within a fixed-scheduled network with time-dependent travel times. It should be noted that the task of finding a path between any two nodes in the network (for example, an ‘Origin’ and a ‘Destination’) and the associated schedule for traversing that path in such a way that certain criteria are optimized (maximized or minimized) is a computation-intensive task. This routing/scheduling/optimization task becomes considerably more complex when one or more of the following itinerary features are present:
Itineraries comprised of multiple passengers (for example, two or more);
In multi-passenger itineraries, coordination and scheduling of non-collocated (i.e., geographically distributed) passengers (e.g., scheduling travel for annual Board of Directors meetings, family reunions, and the like);
Multiple leg-segments and/or destinations;
Passenger-specific arrival and/or departure time preferences or constraints;
Other constraints:
   Budget constraints (global or passenger-specific);
   Desired performance-, service-, or routing-related attributes or constraints (e.g., early boarding, premium economy seating, desired hub connection, etc.);
   Desired ancillary content.

Systematically handling travel-related queries that are characterized by one or more of these attributes require sophisticated routing, scheduling, and optimization capabilities. Extant OTA technology platforms (such as Expedia, Travelocity, and so forth) are largely incapable of handling these types of queries.

The scheduler 230 of the system 200 shown on FIG. 2 may be a purpose-built scheduler capable of handling complex travel-related queries. The system 200 may be operable to use distinctive axes, shapes, colors, and typography. These elements may have tie-ins to trademarked branding elements associated with the system, thereby allowing the user to associate the branding elements of the system 200 with the system 200.

The system 200 may display passenger-specific travel itinerary information relating to flights, hotels, and rental cars, and other ancillary content can be accommodated as well. Furthermore, the system 200 may incorporate a number of interactive features and design elements. The travel itineraries may be revisable for the user—wholly or in part—directly from the user interface of the system 200, e.g., via text or voice.

Structurally, the system 200 may be defined in terms of (i) the generic, defining elements of a travel itinerary, which includes passenger-specific flight, hotel, and car rental information; and (ii) specific attributes or ancillary content instantiated in the original travel-related query (such as desired star rating for hotel accommodations, etc.).

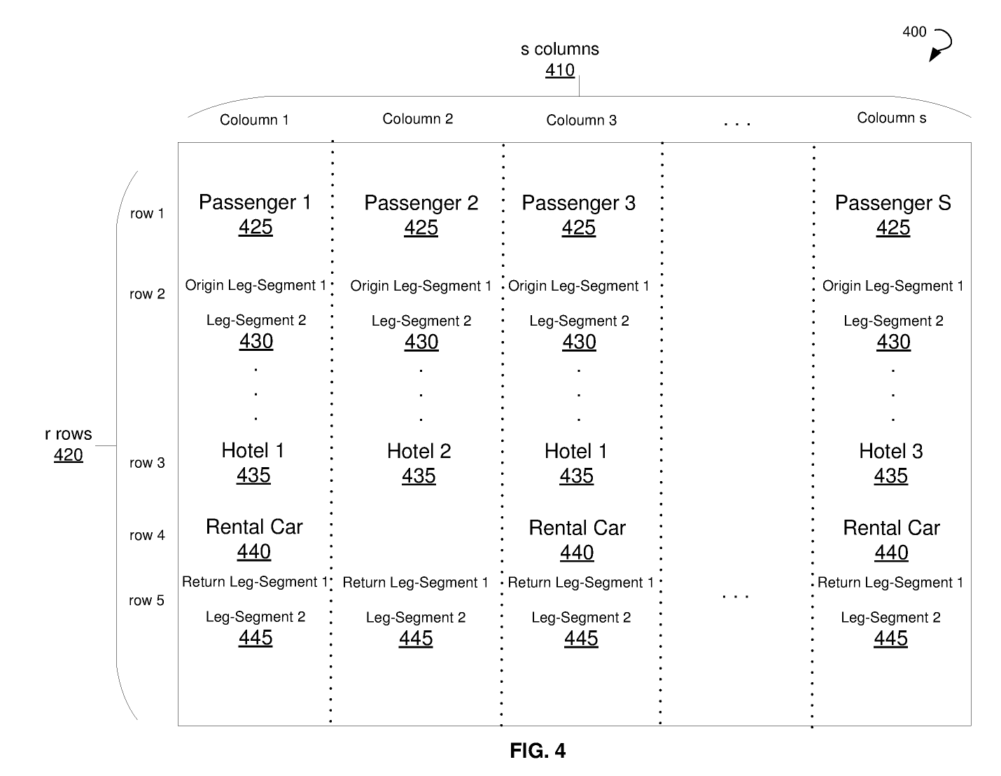

FIG. 4 shows a matrix 400 which can be used to provide a representation of the travel itineraries to the user. The matrix 400 may be comprised of s columns 410, each denoting names 425 of passengers contained in the travel-related query, and r rows 420 that partition each of the columns 410 into regions that convey passenger-specific information pertaining to flights 430, hotels 435, and rental car reservations 440. The matrix 400 may be represented as an (r×s) matrix Z; the row elements associated with each column j=1, 2, . . . , s may be characterized as follows:
Row 1: For z₁ⱼεZ, a name 425 of the j^{th} passenger;
Row 2: Passenger-specific information pertaining to flights 430: flight leg segments associated with an origin city of the j^{th} passenger;
Row 3: When relevant and instantiated within the travel-related query, accommodations related to hotels 435 for the j^{th} passenger;
Row 4: When relevant and instantiated within the travel-related query, rental car reservations 440 for j^{th} passenger;
Row 5: Flight leg-segments 445 for return or continuing flights; and so forth.

The system for facilitating multi-passenger travel reservations can be used to accommodate an arbitrary number of passengers. The only limitations may be practical limitations involving factors such as screen size, font point size, and the like.

Viewed holistically from a user experience perspective, the system for facilitating multi-passenger travel reservations may be designed in a manner that enables the consumer to focus on the defining elements of a multi-passenger travel itinerary, with a view towards enabling the consumer to identify itinerary options that are most likely to prove satisfying or requisite for the consumer. Therefore, the system for facilitating multi-passenger travel reservations may be intended to encourage flow in the creation of truly customized itineraries. Within the system, flow may be evaluated in terms of speed, visual cues, graphical representations of travel segments, interactivity/revise-ability, and so forth.

In an example embodiment, the system for facilitating multi-passenger travel reservations may be configured to evoke or engender a number of emotional and/or affective responses from the consumer. Insofar as the system for facilitating multi-passenger travel reservations provides the visual representation of analytic capabilities, speed, and utility of the system, the system for facilitating multi-passenger travel reservations is directed to engender in the consumer a sense of “the best selected travel itinerary,” or a sense that the system for facilitating multi-passenger travel reservations endeavors to make the path-to-purchase of the consumer as easy as possible.

To the extent that people perceive “attractive” things as more “usable,” the system for facilitating multi-passenger travel reservations may strive to achieve an overall aesthetic that conveys simplicity for the consumer. Furthermore, use of the system for facilitating multi-passenger travel reservations may be ultimately intended to be pleasurable for the consumer.

The system for facilitating multi-passenger travel reservations may be operable to provide collaborative capabilities, thereby enabling groups of two or more passengers to collaboratively construct travel itineraries. These features are intended to engender a sense of collaboration, community, and group creation.

Therefore, the system for facilitating multi-passenger travel reservations may convey to the consumer all of the information necessary to make an informed decision related to the purchase of the travel itinerary.

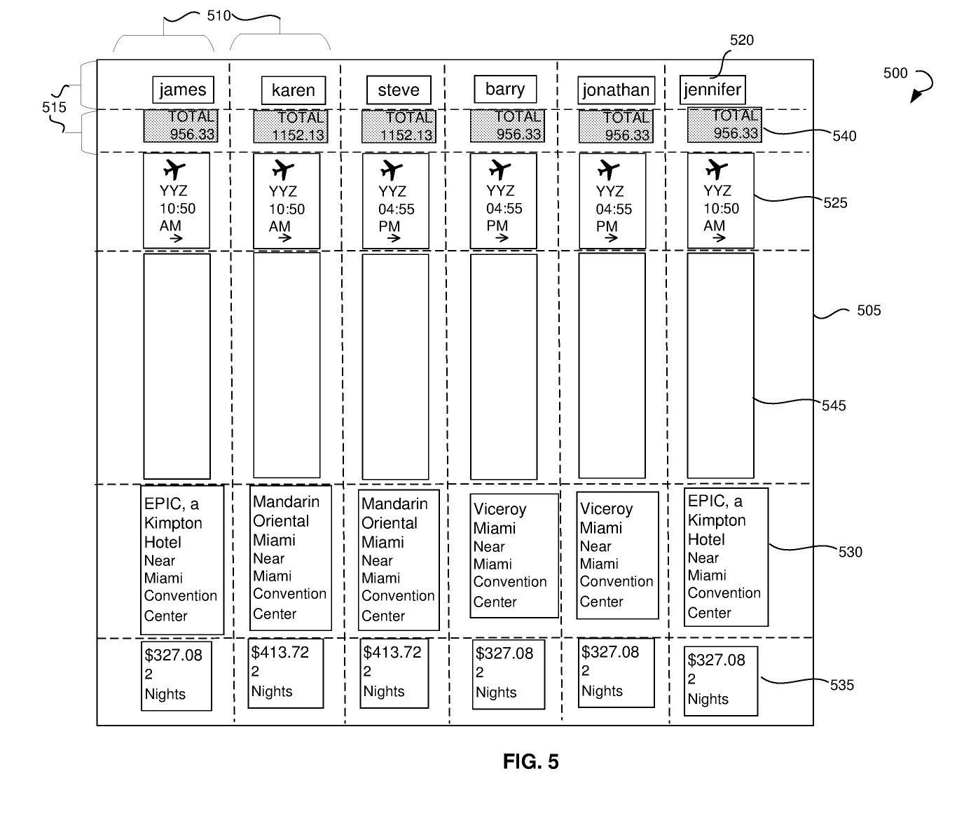

FIGS. 5-14 show example user interfaces provided by the system for facilitating multi-passenger travel reservations.

FIG. 5 is a diagram 500 showing an example user interface displaying results of a search for a multi-passenger travel itinerary for several passengers. The results may be represented in a form of a matrix 505 having columns 510, with one column for each passenger. The matrix 505 may also have a plurality of rows 515. The rows 515 may display passenger-specific information, such as a name 520 of the passenger, flight time 525, hotel information 530, a hotel price 535, a total sum 540 for the whole trip for each passenger, and other information 545. Some segments of the matrix 505 may be visually marked, such as total sum 540 marked grey on FIG. 5.

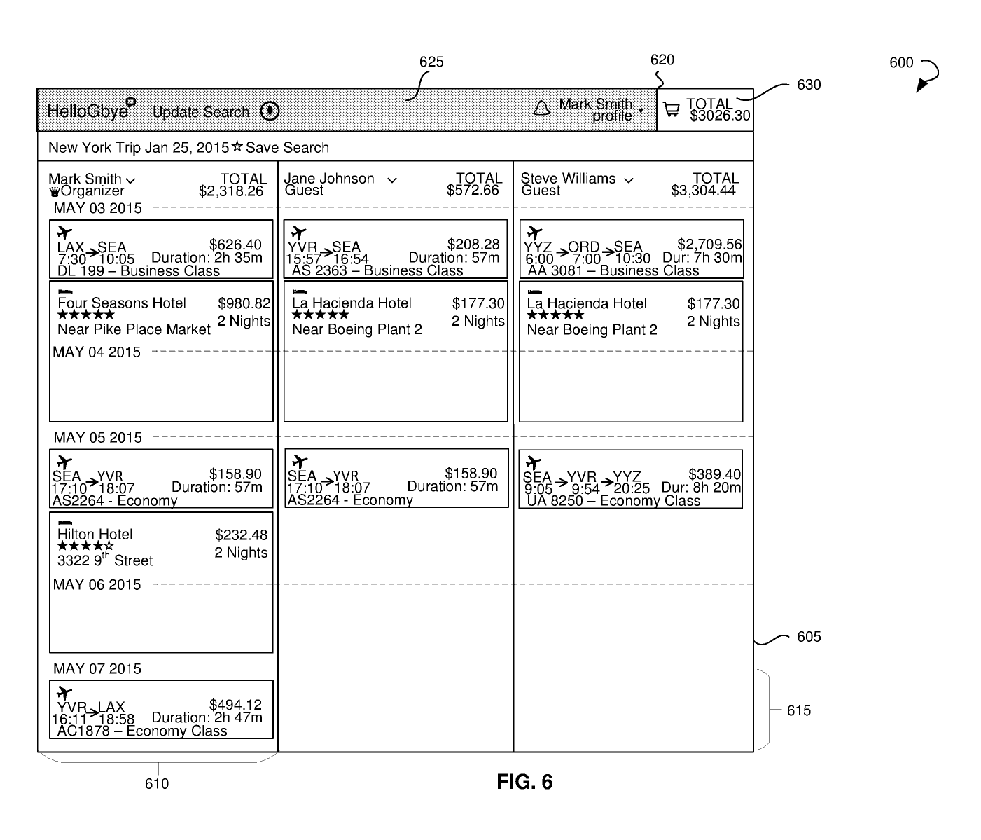

FIG. 6 is a diagram 600 that shows a user interface 620 representing a matrix 605 for displaying a multi-passenger travel itinerary for several passengers, according to an example embodiment. The matrix 605 may have columns 610 and rows 615. Each of the columns 610 may be associated with one passenger. The user interface 620 may include a section 625 displaying information related to a user profile of the user that sends a travel-related query. Additionally, a total sum 630 for all passenger may be displayed on the user interface 620.

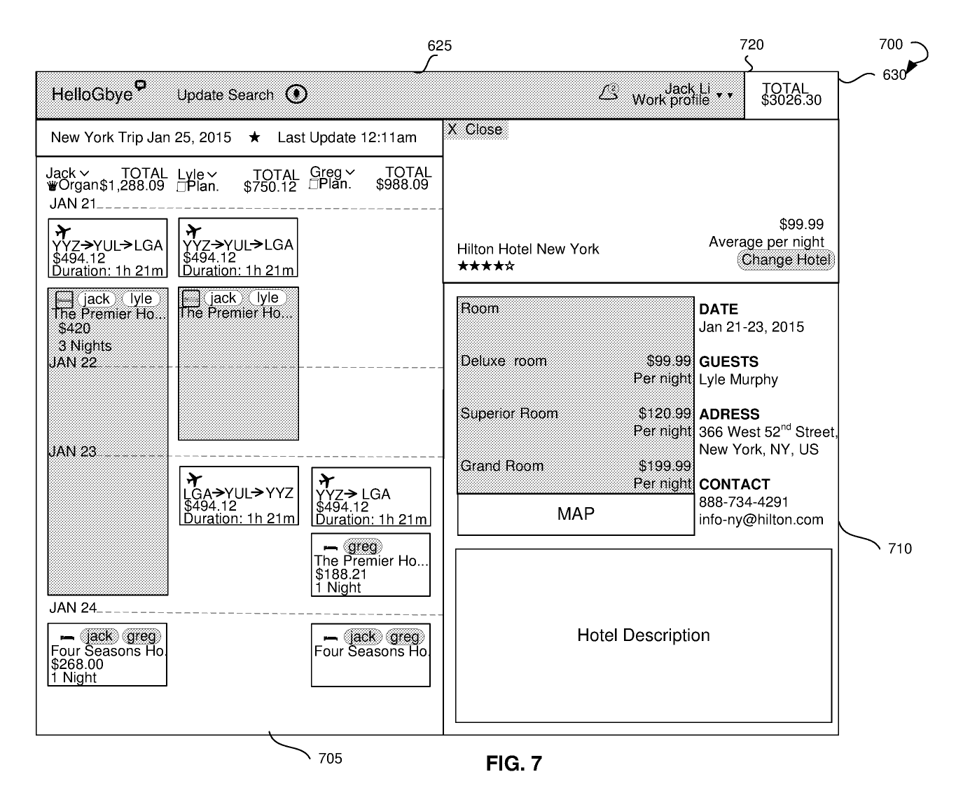

FIG. 7 is a diagram 700 that shows another user interface 720, according to an example embodiment. The user interface 720 may display a matrix 705 for displaying a multi-passenger travel itinerary for several passengers and a hotel description section 710. A user may select a hotel to be displayed in the hotel description section 710. The hotel shown in the hotel description section 710 may include a hotel selected for the one or more passengers of the multi-passenger travel itinerary. In an example embodiment, the user may close the hotel description section 710 if not needed.

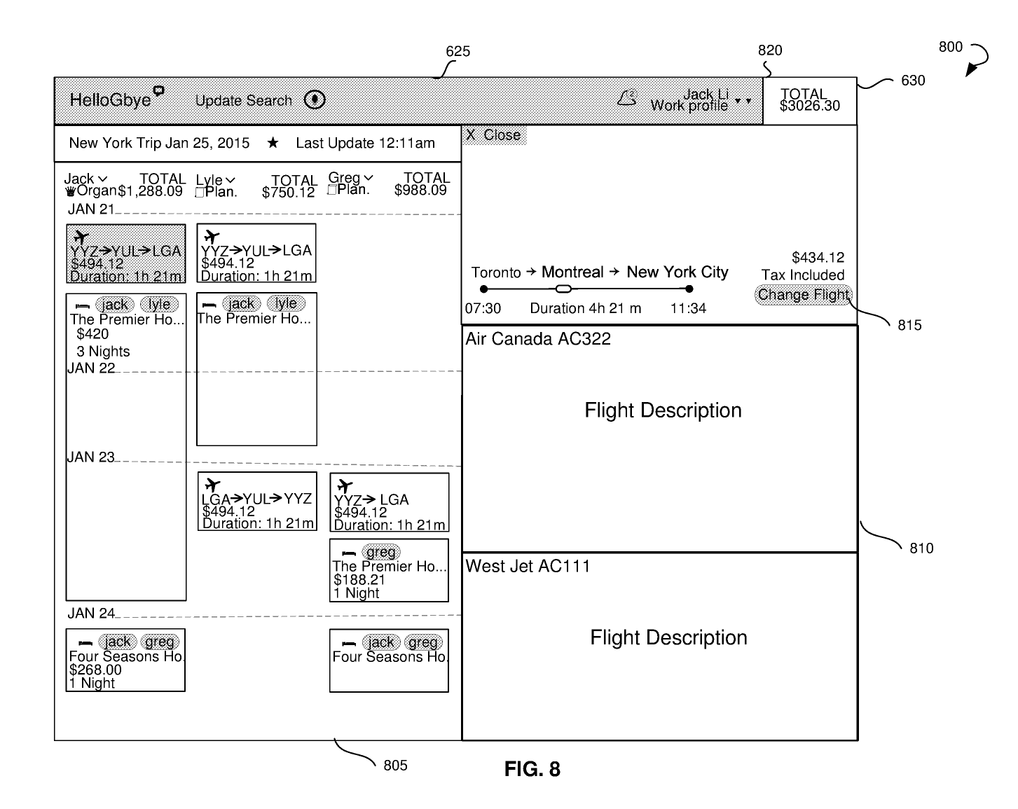

FIG. 8 is a diagram 800 that shows a user interface 820, according to an example embodiment. The user interface 820 may display a matrix 805 for displaying a multi-passenger travel itinerary for several passengers and a flight description section 810. The user may select a flight to be displayed in the flight description section 810. The flight may include a flight selected for the one or more passengers of the multi-passenger travel itinerary. In an example embodiment, the user may close the flight description section 810 if not needed. In a further example embodiment, the flight description section 810 may have a ‘Change Flight’ button 815.

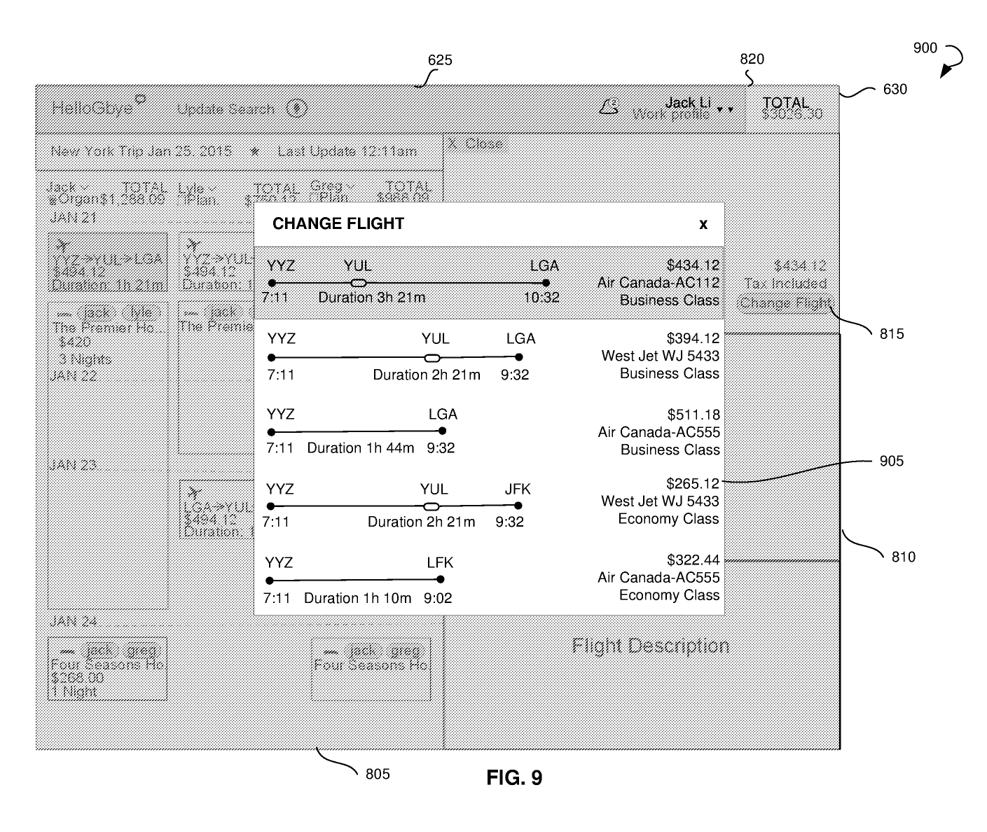

FIG. 9 is a diagram 900 that shows a menu 905 of the user interface 820. The menu 905 may be displayed after the user presses the ‘Change Flight’ button 815. The menu 905 may show a list of feasible flights selected for the passenger during the search. Upon reviewing flight information shown in the menu 905, such as departure time, arrival time, flight duration, number of flight connections, and a flight price, the user may select the flight.

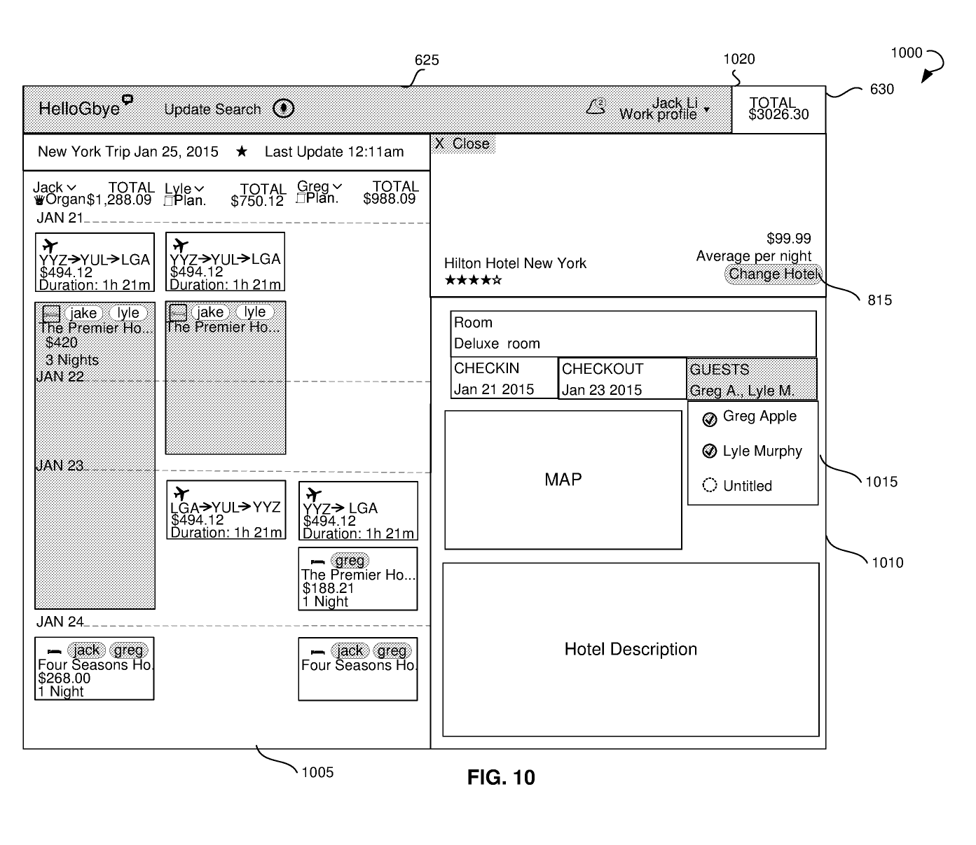

FIG. 10 is a diagram 1000 that shows a user interface 1020, according to an example embodiment. The user interface 1020 may display a matrix 1005 for displaying a multi-passenger travel itinerary for several passengers and a hotel description section 1010. The hotel description section 1010 may include hotel-specific information, such as a hotel rating, a check-in time, a check-out time, a map with the hotel depicted on the map, and a hotel description. Additionally, a list 1015 of passengers may be displayed to show passengers for which this hotel is selected according to the multi-passenger travel itinerary. In an example embodiment, the user may close the hotel description section 1010 if not needed.

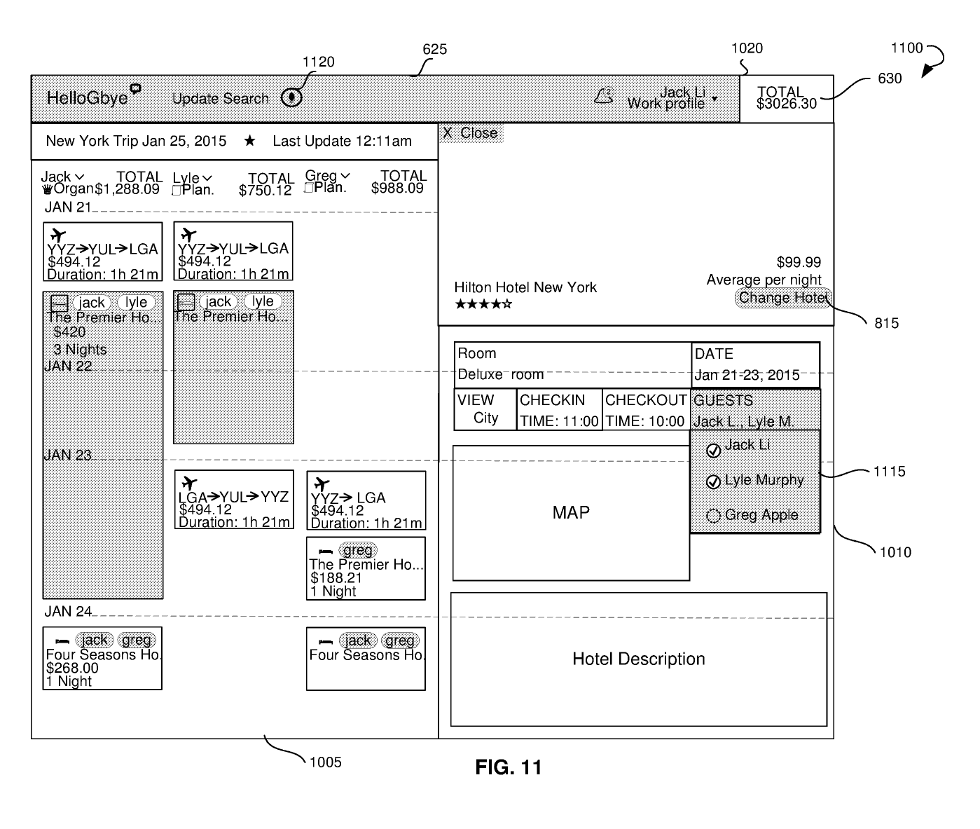

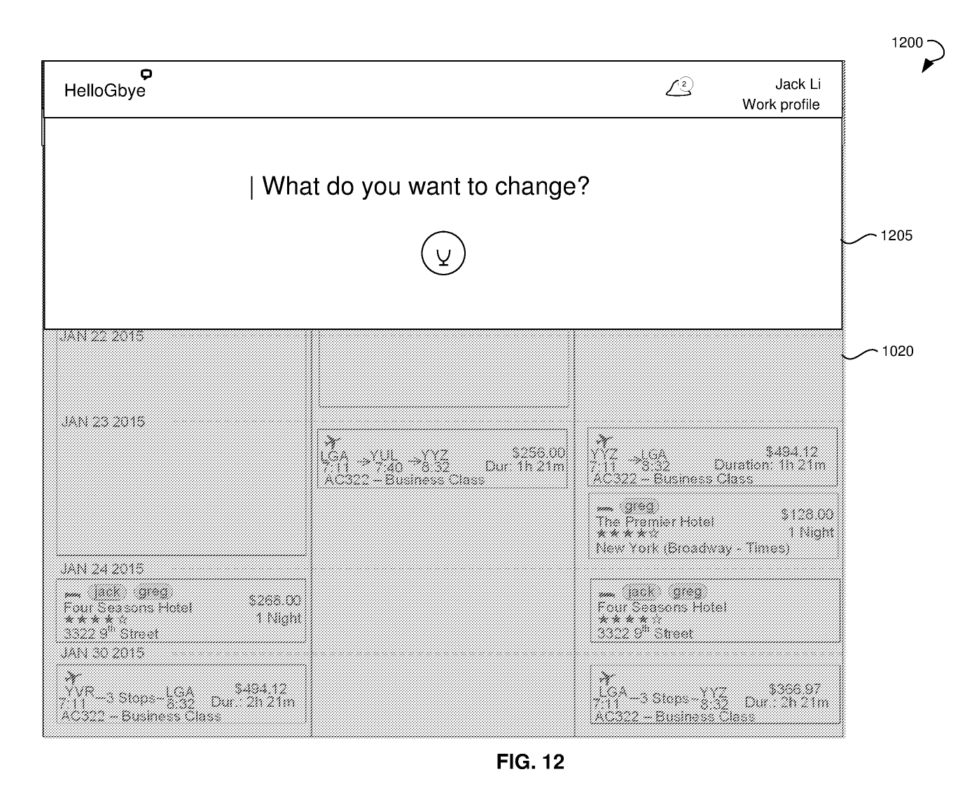

FIG. 11 is a diagram 1100 that shows a user interface 1020, according to another example embodiment. The user interface 1020 may enable the user to add one or more passengers to a list 1115 of passengers. Based on such addition, the hotel shown in the hotel description section 1010 may be also selected for the passenger added by the user to the list 1115 of passengers. Moreover, the user interface 1020 may have an ‘Update Search’ button 1120, described in detail with reference to FIG. 12.

FIG. 12 is a diagram 1200 that shows a user interface 1020, according to another example embodiment. Upon selecting the ‘Update Search’ button 1120 shown on FIG. 11, a section 1205 may be displayed to the user. The section 1205 may provide an incentive for the user to change one or more attribute values of the multi-passenger travel itinerary (e.g., the section 1205 may have a text “What do you want to change?” or the like. The user may provide a response, or a revision request, to the incentive by voice, text, or by selecting one or more attribute values shown on the user interface 1020).

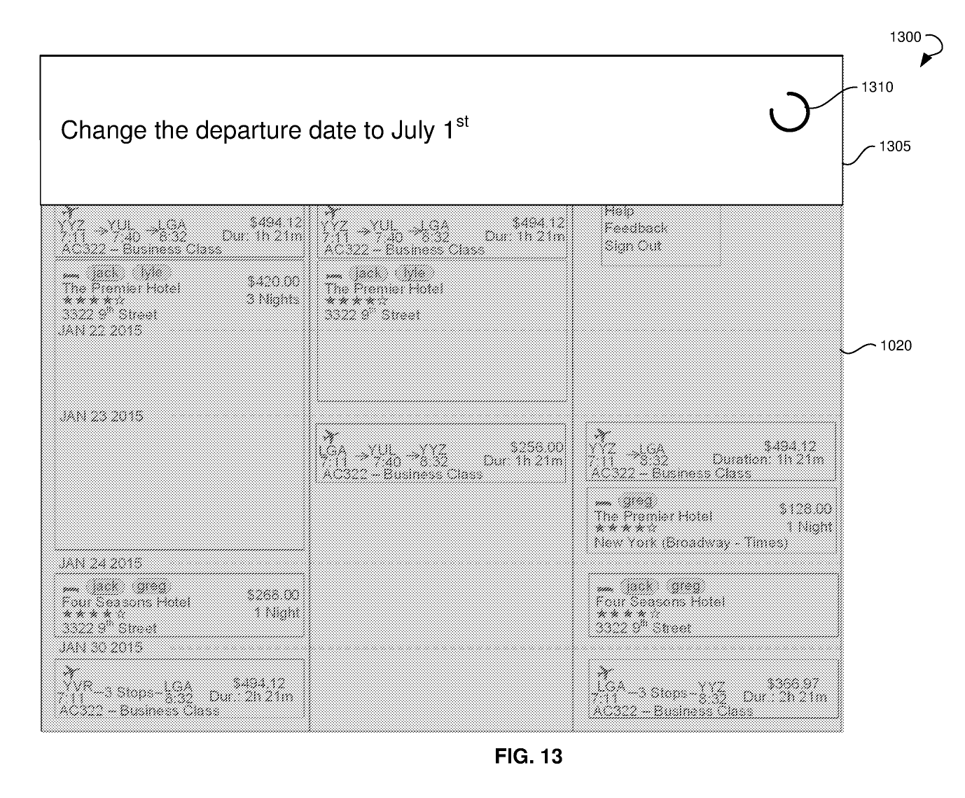

FIG. 13 is a diagram 1300 that shows a user interface 1020, according to another example embodiment. Upon receipt of the response from the user, the response may be parsed and displayed on the user interface 1020 in a section 1305. Therefore, the user may see the parsed text of the revision request and a progress of introducing changes into the multi-passenger travel itinerary. The progress may be represented as a pie chart 1310.

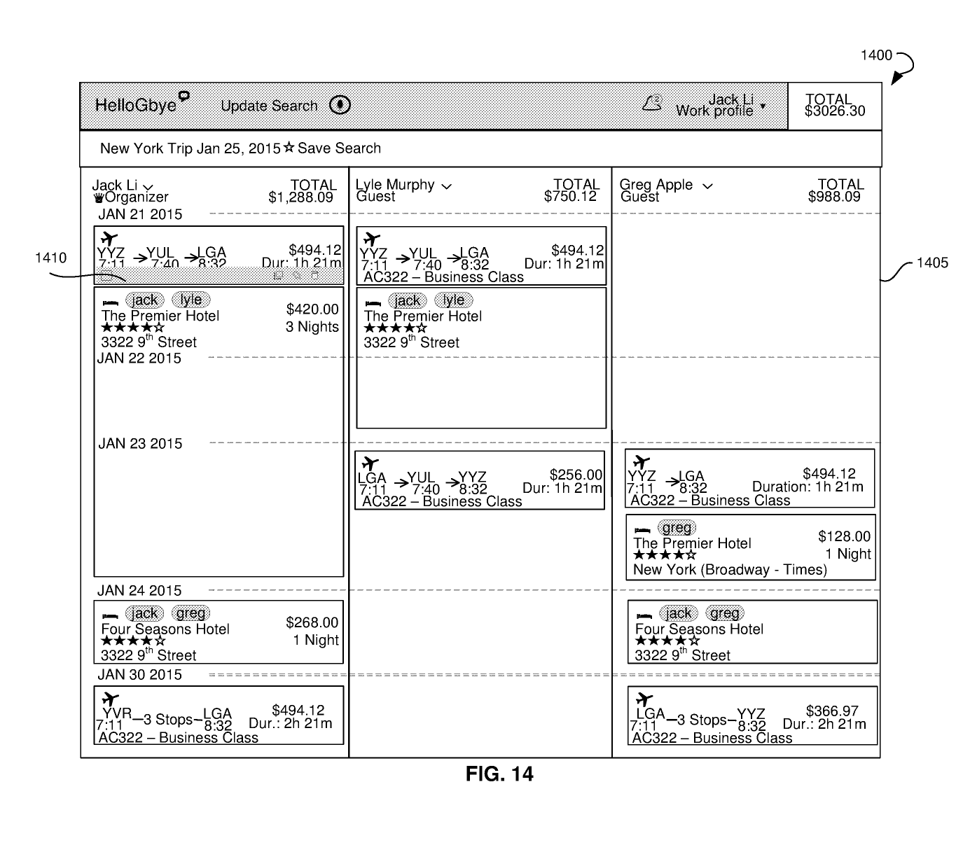

FIG. 14 is a diagram 1400 that shows a user interface 1405, according to another example embodiment. The user interface 1405 may have a panel 1410 by means of which the user may hide or pin some sections displayed on the user interface 1405.

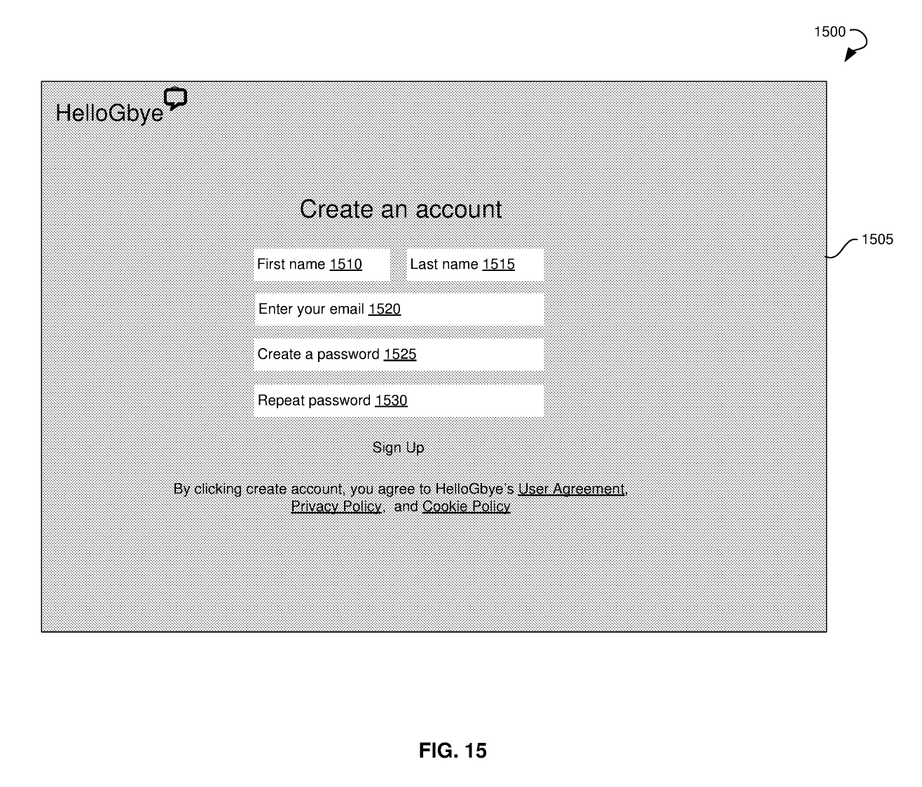

FIGS. 15-21 show example user interfaces related to a user profile in the system for facilitating multi-passenger travel reservations.

FIG. 15 is a diagram 1500 showing a user interface 1505 displayed to a user when the user initiates a process of registration in the system 200 for facilitating multi-passenger travel reservations. The user may need to fill-in a registration form, which may include a first name field 1510, a last name field 1515, an email field 1520, a password field 1525, a repeat password field 1530, and so forth.

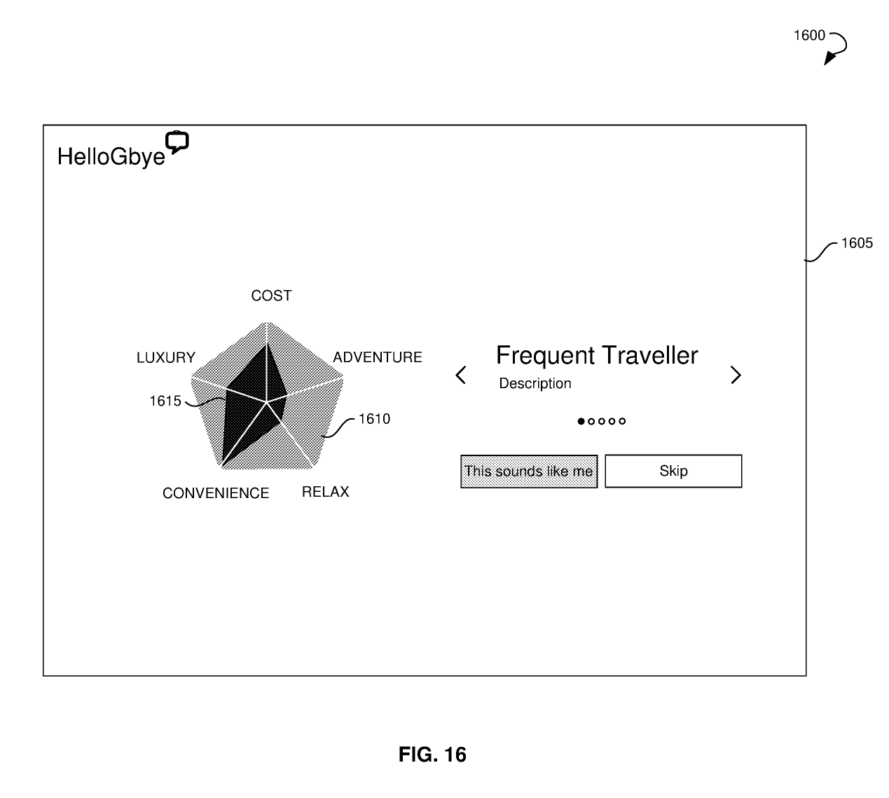

FIG. 16 is a diagram 1600 showing a user interface 1605, according to an example embodiment. The user interface 1605 may be displayed to the user after filling-in the registration form shown on FIG. 15. More specifically, the user may be requested to provide user preferences regarding multi-passenger travel itineraries. The system for facilitating multi-passenger travel reservations may have a plurality of predefined types of user profiles with predefined sets of user preferences. A vector diagram 1610 may be displayed to the user to show specific user preferences of a predefined type of user profile. The vector diagram 1610 may show categories of the user preferences, such as cost, adventure, relax, convenience, luxury, and the like. The user may set weights for each of the categories by moving corners of a polygon 1615 shown on the vector diagram 1610.

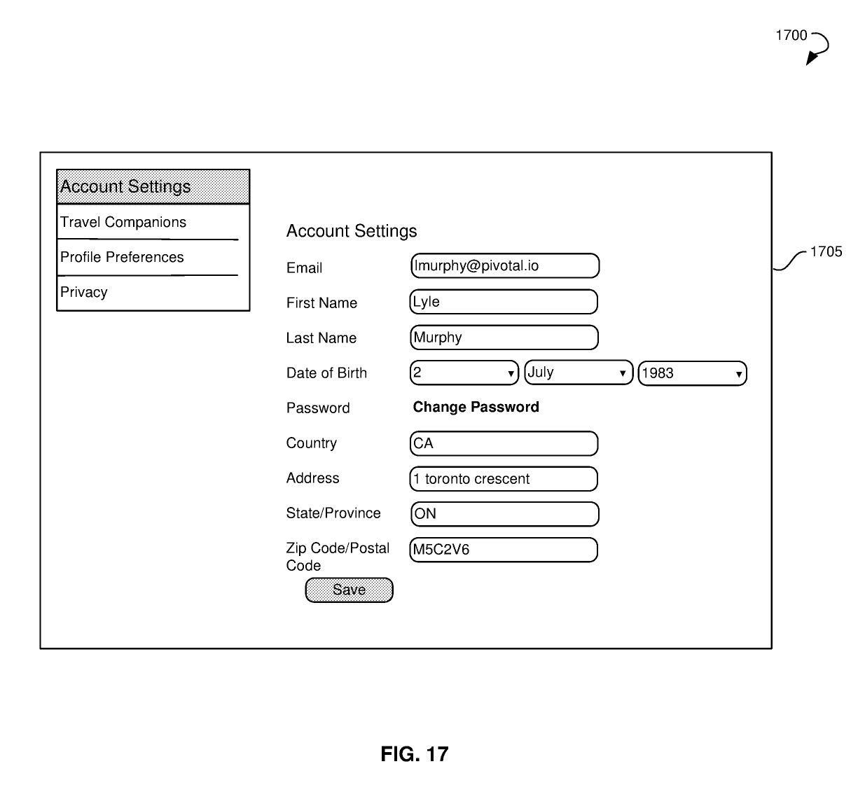

FIG. 17 is a diagram 1700 showing a user interface 1705, according to an example embodiment. The user interface 1705 may be displayed to the user after filling-in the registration form shown on FIG. 15. More specifically, the user may be requested to set account settings. The account settings may include user personal data, such as date of birth, address, and the like.

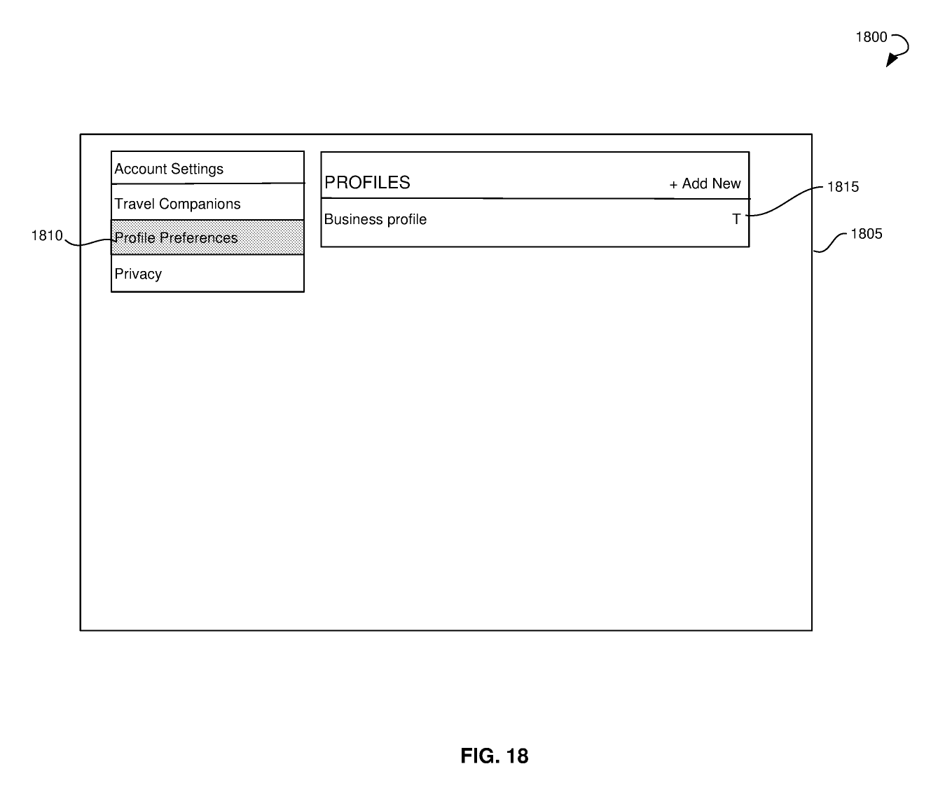

FIG. 18 is a diagram 1800 showing a user interface 1805, according to an example embodiment. The user interface 1805 may be displayed to the user after filling-in the registration form shown on FIG. 15. More specifically, the user may be requested to set profile preferences 1810, such as a type of user profile 1815. The types of user profile 1815 may include a business profile, a family profile, a leisure profile, a corporate profile, and the like. Therefore, one user may have several sub-profiles enabling the user to search for multi-passenger travel itineraries related to a user's work in the business profile and search for multi-passenger travel itineraries related to family trips of the user in the family profile.

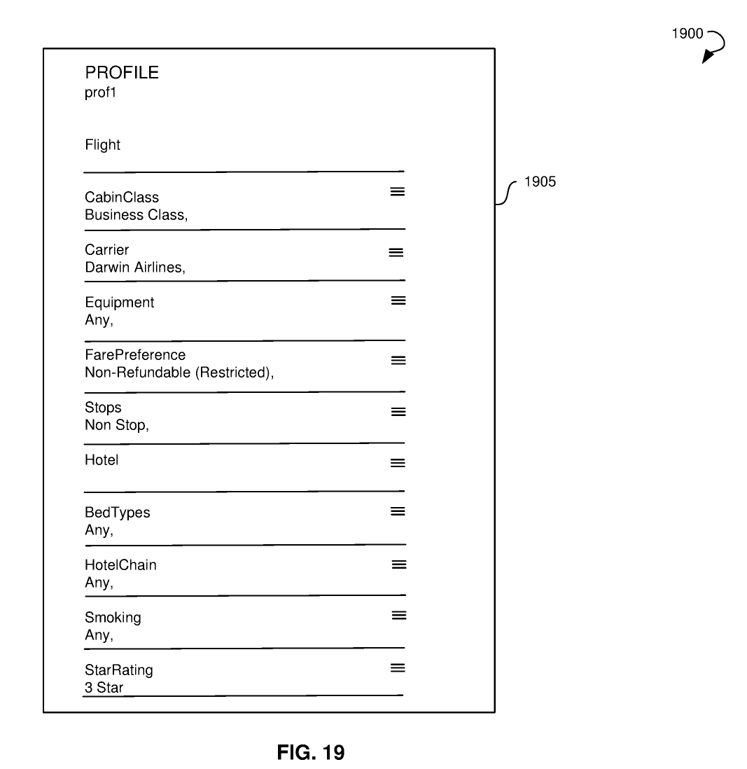

FIG. 19 is a diagram 1900 showing a user interface 1905, according to an example embodiment. The user interface 1905 may be displayed to the user upon selection of the type of user profile 1815 shown on FIG. 18. More specifically, the user may review and select profile preferences associated with the selected type of user profile.

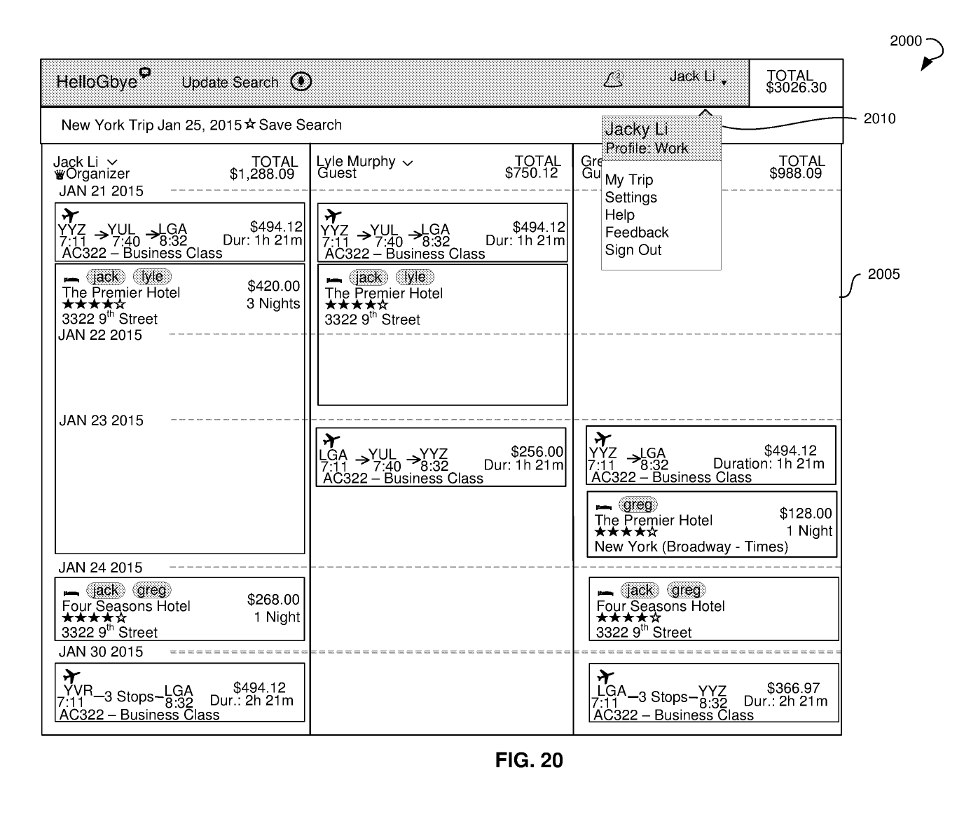

FIG. 20 is a diagram 2000 showing a user interface 2005, according to an example embodiment. After completion of the process of registration, the user may review or change data related to the user profile by selecting a profile menu 2010.

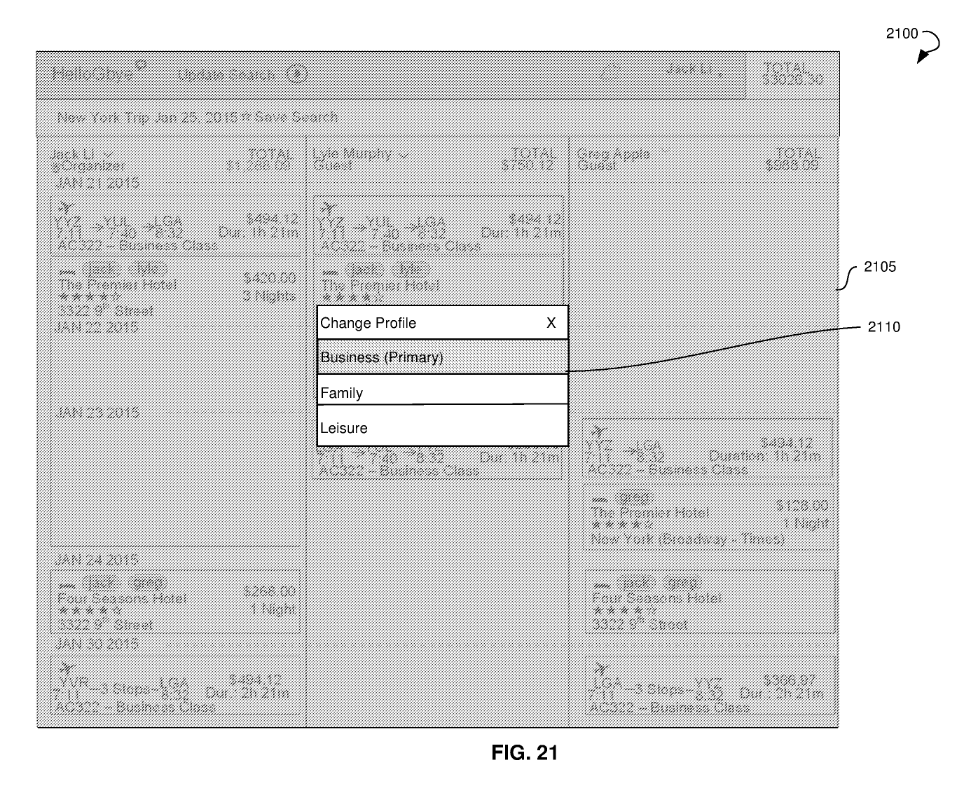

FIG. 21 is a diagram 2100 showing a user interface 2105, according to an example embodiment. The user may change the type of the user profile by selecting the type of user profile in a section 2110 displayed to the user.

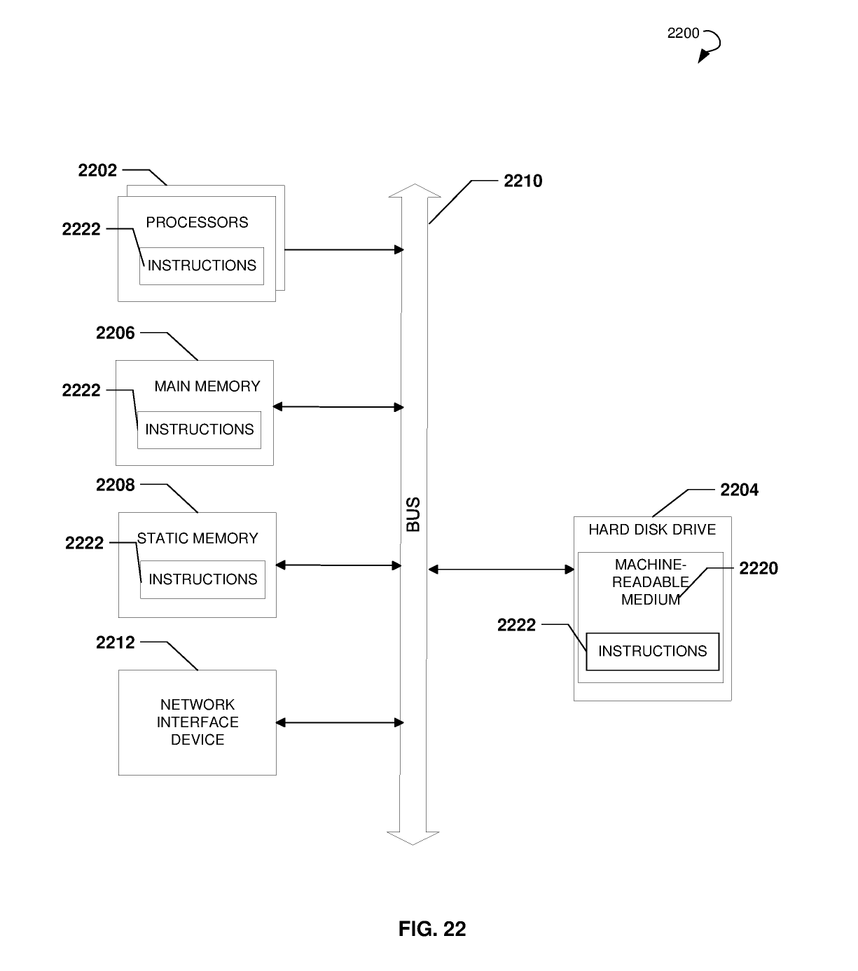

FIG. 22 shows a diagrammatic representation of a computing device for a machine in the exemplary electronic form of a computer system 2200, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 2200 includes a processor or multiple processors 2202, a hard disk drive 2204, a main memory 2206, and a static memory 2208, which communicate with each other via a bus 2210. The computer system 2200 may also include a network interface device 2212. The hard disk drive 2204 may include a computer-readable medium 2220, which stores one or more sets of instructions 2222 embodying or utilized by any one or more of the methodologies or functions described herein. The instructions 2222 can also reside, completely or at least partially, within the main memory 2206 and/or within the processors 2202 during execution thereof by the computer system 2200. The main memory 2206 and the processors 2202 also constitute machine-readable media.

While the computer-readable medium 2220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 2200 may be implemented as a cloud-based computing environment, such as a virtual machine operating within a computing cloud. In other embodiments, the computer system 2200 may itself include a cloud-based computing environment, where the functionalities of the computer system 2200 are executed in a distributed fashion. Thus, the computer system 2200, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for facilitating multi-passenger travel reservations are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for facilitating multi-passenger travel reservations, the system comprising:
a processor operable to:
receive a travel-related query, the travel-related query being associated with a plurality of passengers;
based on the travel-related query, ascertain a plurality of attribute sets, each of the plurality of attribute sets being associated with one of the plurality of passengers;
instantiate, for each of the plurality of passengers, at least one attribute of the plurality of attribute sets with attribute values; and
based on searching, present at least one multi-passenger travel itinerary for each of the plurality of passengers;
a parser in communication with the processor and operable to:
parse the travel-related query to derive the attribute values related to the plurality of attribute sets; and
a scheduler in communication with the processor and operable to:
search, for each of the plurality of passengers, for feasible travel itineraries based on the least one attribute and user preferences.

2. The system of claim 1, wherein the presenting includes visualizing itinerary information associated with each of the plurality of passengers, wherein the itinerary information is associated with the at least one multi-passenger travel itinerary for each of the plurality of passengers, wherein the itinerary information includes at least flight information and one or more of the following: hotel information and rental car information.

3. The system of claim 1, wherein the processor is further operable to:
receive a revision request, the revision request being associated with at least one of the plurality of passengers, the revision request being associated with an alteration of at least one of the attribute values or an addition of a further attribute value; and
based on the revision request, instantiate a further attribute with an altered derived attribute value or the further attribute value; and
wherein the scheduler is further operable to search, based on the instantiating, for further feasible travel itineraries based on the further attribute.

4. The system of claim 1, wherein the processor is further operable to:
rank the at least one attribute based at least on the user preferences; and
assign weights to the at least one attribute based on the ranking to create at least one weighted attribute.

5. The system of claim 4, wherein the presenting includes:
identifying, based on the weights, one or more attributes having highest weights; and
visually marking the one or more attributes having the highest weights.

6. The system of claim 5, wherein the presenting further includes providing visual cues, the visual cues being associated with the one or more attributes having the highest weights.

7. The system of claim 5, wherein the processor is further operable to select the at least one multi-passenger travel itinerary from the feasible travel itineraries, wherein the at least one multi-passenger travel itinerary is associated with the one or more attributes having the highest weights.

8. The system of claim 1, wherein the presenting includes visualizing segments of the at least one multi-passenger travel itinerary.

9. The system of claim 1, wherein the at least one multi-passenger travel itinerary for each of the plurality of passengers is presented as a matrix, the matrix comprising a plurality of columns and a plurality of rows, each of the plurality of columns being associated with one of the plurality of passengers, each of the plurality of rows being associated with at least flight information.

10. The system of claim 9, wherein the each of the plurality of rows is further associated with one or more of the following: hotel information, rental car information, return flight information, and continuing flight information.

11. A method for facilitating multi-passenger travel reservations, the method comprising:
receiving, by a processor, a travel-related query, the travel-related query being associated with a plurality of passengers;
based on the travel-related query, ascertaining, by the processor, a plurality of attribute sets, each of the plurality of attribute sets being associated with one of the plurality of passengers;
parsing, by a parser, the travel-related query to derive attribute values related to the plurality of attribute sets;
instantiating, by the processor, for each of the plurality of passengers, at least one attribute of the plurality of attribute sets with the attribute values;
searching, by a scheduler, for each of the plurality of passengers, for feasible travel itineraries based on the least one attribute and user preferences; and
based on the searching, presenting, by the processor, at least one multi-passenger travel itinerary for each of the plurality of passengers.

12. The method of claim 11, wherein the presenting includes visualizing itinerary information associated with each of the plurality of passengers, wherein the itinerary information is associated with the at least one multi-passenger travel itinerary for each of the plurality of passengers, wherein the itinerary information includes at least flight information and one or more of the following: hotel information and rental car information.

13. The method of claim 11, further comprising:
receiving, by the processor, a revision request, the revision request being associated with at least one of the plurality of passengers, the revision request being associated with an alteration of at least one of the attribute values or an addition of a further attribute value;
based on the revision request, instantiating, by the processor, a further attribute with an altered derived attribute value or the further attribute value; and
based on the instantiating, searching, by the scheduler, for further feasible travel itineraries based on the further attribute.

14. The method of claim 11, further comprising:
ranking, by the processor, the at least one attribute based at least on the user preferences; and
assigning weights, by the processor, to the at least one attribute based on the ranking to create at least one weighted attribute.

15. The method of claim 14, wherein the presenting includes:
identifying, based on the weights, one or more attributes having highest weights; and
visually marking the one or more attributes having the highest weights.

16. The method of claim 15, wherein the presenting further includes providing visual cues, the visual cues being associated with the one or more attributes having the highest weights.

17. The method of claim 15, further comprising selecting, by the processor, the at least one multi-passenger travel itinerary from the feasible travel itineraries, wherein the at least one multi-passenger travel itinerary is associated with the one or more attributes having the highest weights.

18. The method of claim 11, wherein the presenting includes visualizing segments of the at least one multi-passenger travel itinerary.

19. The method of claim 11, wherein the at least one multi-passenger travel itinerary for each of the plurality of passengers is presented as a matrix, the matrix comprising a plurality of columns and a plurality of rows, each of the plurality of columns being associated with one of the plurality of passengers, each of the plurality of rows being associated with at least flight information.

20. A system for facilitating multi-passenger travel reservations, the system comprising:
a processor operable to:
receive a travel-related query, the travel-related query being associated with a plurality of passengers;
based on the travel-related query, ascertain a plurality of attribute sets, each of the plurality of attribute sets being associated with one of the plurality of passengers;
instantiate, for each of the plurality of passengers, at least one attribute of the plurality of attribute sets with attribute values;
rank the at least one attribute based at least on the user preferences;
assign weights to the at least one attribute based on the ranking to create at least one weighted attribute; and
based on searching, present at least one multi-passenger travel itinerary for each of the plurality of passengers, wherein the presenting includes:
identifying, based on the weights, one or more attributes having highest weights, and visually marking the one or more attributes having the highest weights, wherein the at least one multi-passenger travel itinerary for each of the plurality of passengers is presented as a matrix, the matrix comprising a plurality of columns and a plurality of rows, each of the plurality of columns being associated with one of the plurality of passengers, each of the plurality of rows being associated with at least flight information;
a parser in communication with the processor and operable to:
parse the travel-related query to derive the attribute values related to the plurality of attribute sets; and
a scheduler in communication with the processor and operable to:
search, for each of the plurality of passengers, for feasible travel itineraries based on the least one attribute and user preferences.
